(19) United States
(12) Patent Application Publication
(10) Pub. No.: US 2013/0044592 A1
(43) Pub. Date: Feb. 21, 2013

(54) APPARATUS AND METHOD FOR SCHEDULING OF ADAPTIVE GRANT AND POLLING SERVICE IN A BROADBAND WIRELESS ACCESS SYSTEM

(71) Applicants: Jeongki Kim, Anyang-si (KR); Kiseon Ryu, Anyang-si (KR); Youngsoo Yuk, Anyang-si (KR)

(72) Inventors: Jeongki Kim, Anyang-si (KR); Kiseon Ryu, Anyang-si (KR); Youngsoo Yuk, Anyang-si (KR)

(73) Assignee: LG Electronics Inc., Seoul (KR)

(21) Appl. No.: 13/583,575

(22) PCT Filed: Mar. 2, 2011
(86) PCT No.: PCT/KR11/01440

§ 371 Date: Sep. 7, 2012

Related U.S. Application Data
(60) Provisional application No. 61/312,623, filed on Mar. 10, 2010.

(30) Foreign Application Priority Data
Dec. 21, 2010 (KR) 10-2010-0131883

(51) Int. Cl. H04W 28/10

(52) U.S. Cl. 370/229

(57) ABSTRACT

Disclosed is a method for performing uplink scheduling for an adaptive grant and polling (aGP) service in a broadband wireless access system, the method comprising: transmitting a first message for requesting the switching or changing of a QoS (quality of service) parameter set to a base station; receiving, from the base station, a service specific scheduling control header including adaptation start time information for adapting a new QoS parameter set; and switching or changing to the new QoS parameter set at the checked adaptation start time after checking the adaptation start time information within the received service specific scheduling control.

### TECHNICAL FIELD

The present disclosure relates to an uplink scheduling method and apparatus in a broadband wireless access system, and more particularly, to a scheduling method and apparatus for an adaptive grant and polling (aGP) service.

### BACKGROUND ART

Scheduling Services

Scheduling services indicates a data handling mechanism supported by a MAC scheduler for data transmission in a service connection. Each service flow is associated with a scheduling service as in a Wireless-MAN-OFDMA R1 Reference system.

The scheduling service is determined by a set of SF quality of service (QoS) parameters. Such quality of service parameters may be designed or modified by using service flow management operations.

aGP Service (Adaptive Grant and Polling Service)

In 802.16m, an adaptive grant and polling (aGP) service is adopted as an uplink scheduling service to improve the performance of VoIP scheduling.

One of the main features of the aGP service is to provide a method in which each

QoS parameter is defined for each state when one service such as VoIP is operated in two states, and upon reaching the relevant state, uplink scheduling is carried out by using quality of service (QoS) parameters corresponding to the relevant state.

For example, in case where QoS parameter set 1 is defined for the active state of VoIP and QoS parameter set 2 for the inactive state thereof, the set 1 may be applied thereto if the VoIP is in an active state, and the set 2 may be applied thereto if it is in an inactive state.

According to circumstances, it may be also possible to change the relevant parameter value in addition to switch the quality of service (QoS) parameter of the relevant service. The changing of a QoS parameter has been carried out through a dynamic service change (DSC) procedure in the existing system, but the request for switching a set of QoS parameters or changing a value of QoS parameter can be made by a terminal through a quick access message, a Service Scheduling Control Header or a BR indicator of the fast feedback channel in the aGP service.

An embodiment of the Service Scheduling Control Header is illustrated in the following Table 1, which is a format of the Service Specific Scheduling Control Header (SSSCH).

TABLE 1

| | Size | |
|---|---|---|
| Syntax | (bit) | Notes |
| Service Specific | | |
| Scheduling Control | | |
| Header( ) { | | |
| . . . | | |
| if (scheduling type == | | |
| aGP Service) { | | |
| QoS parameter change | 1 | QoS parameter change indicator |
| indicator | | 0: no change in QoS parameter |
| | | 1: having changes in QoS parameter |
| SCID change indicator | 1 | |
| if (QoS parameter change | | |
| indicator = 1){ | | |
| Running Grant Polling | 6 | Indicating new GPI (frames) to use |
| Interval (GPI) | | for future allocation. |
| Reserved | 9 | |
| }else{ | | |
| QoS parameter set switch | 1 | 0: primary QoS parameter set. |
| | | 1: secondary QoS parameter set |
| } | | |
| . . . | | |
| } | | |

When desired to switch or change QoS parameters for one service at a specific time, the terminal transmits a Service Specific Scheduling Control Header (SSSCH) to the base station. Upon receiving SSSCH from the terminal, the base station switches or changes QoS parameters for a service flow of the terminal using parameters included in the SSSCH.

Here, in case where a QoS parameter has been switched or changed in the aGP service, it is not defined when the switched or changed QoS parameter will be adapted by the base station and terminal. If the adaptation timing of the switched or changed QoS is defined subsequent to transmitting or receiving SSSCH, the following problem will be occurred.

It is assumed that QoS parameter set 1 (grant interval is 20 ms) is defined in an active move, QoS parameter set 2 (grant interval is 160 ms) is defined in inactive mode, and the terminal is transitioned from the active state to the inactive state.

In this case, if the terminal transmits SSSCH to the base station to switch a QoS parameter set but the terminal does not receive it, then the terminal operates in the QoS parameter set 2 and the base station operates in the QoS parameter set 1.

At this time, the base station performs scheduling every 20 ms in the QoS parameter set 1, thereby causing the consumption of resources.

In this case, assuming that the terminal does not enter a sleep mode, then the terminal should transmit padding PDU since there is no packets to be sent whenever UL resources are allocated thereto. As a result, the terminal unnecessarily consumes power.

Furthermore, when entering an inactive mode out of an active mode of VoIP, then the terminal using an AMR code generates and transmits a first SID packet, and then generates a second SID packet 40 ms later.

Here, it may cause an inconsistency between the timing of actually generating a packet and the timing of allocating a resource. In this case, if the terminal operates in a sleep mode corresponding to the QoS parameter set 1 in an active mode, and operates in a sleep mode corresponding to the QoS parameter set 2 in an inactive mode, and HARQ retransmission is generated in the MAC PDU of SSSCH, then the timings of actually starting a sleep cycle in the base station and terminal will be inconsistent.

Furthermore, in the foregoing case, the sleep parameters are differently adapted thereto, thereby causing a serious problem in the sleep operation.

### DISCLOSURE OF INVENTION

### Solution to Problem

One aspect of the present disclosure is to provide a method of informing the terminal of a timing at which the base station is switched or changed when the quality of service (QoS) parameter set of the relevant service is switched or changed at a specific timing in an adaptive grant and polling (aGP).

Furthermore, another aspect of the present disclosure is to provide a method of allowing the terminal or base station to show acceptance or rejection in response to a request for changing a QoS parameter set.

According to the present disclosure, there is provided a method for performing uplink scheduling for an adaptive grant and polling (aGP) service in a broadband wireless access system, the method comprising: transmitting a first message for requesting the switching or changing of a QoS (quality of service) parameter set to a base station; receiving, from the base station, a service specific scheduling control header including adaptation start time information for adapting a new QoS parameter set; and switching or changing to the new QoS parameter set at the checked adaptation start time after checking the adaptation start time information within the received service specific scheduling control.

Furthermore, it is characterized in that the new QoS parameter set may include QoS parameters suggested by the terminal or alternative QoS parameters assigned by the base station.

Furthermore, it is characterized in that the adaptation start time information has a frame offset form indicating the switching or changing subsequent to a predetermined number of frames after receiving the SSSCH.

Furthermore, it is characterized in that the adaptation start time information indicates the least significant bit (LSB) 4 bits of the frame number that should be switched or changed to a new QoS parameter set.

Furthermore, it is characterized in that the first message is any one of a service specific scheduling control header (SSSCH), a quick access message, and a bandwidth request indicator of a feedback channel.

Furthermore, it is characterized in that the SSSCH further comprises SSSCH-type information for discriminating whether the SSSCH is a request for switching or changing a QoS parameter set or a response with respect to the request.

Furthermore, it is characterized in that wherein the SSSCH further comprises an adaptation start time information indicator indicating whether the adaptation start time information is included in the SSSCH.

Furthermore, according to the present disclosure, there is provided an operation method of a terminal for performing uplink scheduling for an adaptive grant and polling (aGP) service in a broadband wireless access system, and it is characterized in that the method may include receiving SSSCH for requesting the switching or changing of a QoS parameter set from the base station; transmitting a response message indicating permission or rejection with respect to the request to the base station; and maintaining the existing QoS parameter set or switching or changing to a new QoS parameter set based on the response.

Furthermore, it is characterized in that the switching or changing to the new QoS parameter set is performed subsequent to receiving the response message at the base station.

Furthermore, it is characterized in that in case of permission with respect to the request, the response message is adaptation ACK.

Furthermore, it is characterized in that in case of rejection with respect to the request, the response message is adaptation NACK.

Furthermore, according to the present disclosure, there is provided a terminal for performing uplink scheduling for an adaptive grant and polling (aGP) service in a broadband wireless access system, and it is characterized in that the terminal may include a transmission unit configured to transmit a first message for requesting the switching or changing of a QoS parameter set to a base station; a receiving unit configured to receive a service specific scheduling control header (SSSCH) including adaptation start time information for adapting a new QoS parameter set from the base station; and a controller configured to control to switch or change to the new QoS parameter set at the checked adaptation start time after checking the adaptation start time information within the received service specific scheduling control.

According to the present disclosure, adaptation start time is defined in an aGP service, and a method of allowing a base station or terminal to reject a request for changing QoS parameters is added thereto, thereby effectively performing uplink scheduling in the aGP service.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view illustrating a method of allowing a base station to transmit SSSCH including adaptation start time information with respect to a terminal's request for switching or changing a QoS parameter set according to a first embodiment of the present disclosure;

FIG. 2 is a view illustrating a method of allowing the base station to transmit adaptation ACK in response to a terminal's adaptation request in an AMS initiated adaptation according to a first embodiment of the present disclosure;

FIG. 3 is a view illustrating a method of allowing the base station to transmit adaptation NACK in response to a terminal's adaptation request in an AMS initiated adaptation according to a first embodiment of the present disclosure;

FIG. 4 is a view illustrating a method of allowing the terminal to transmit adaptation ACK in response to a terminal's adaptation request in an ABS initiated adaptation according to a second embodiment of the present disclosure;

FIG. 5 is a view illustrating a method of allowing the terminal to transmit adaptation NACK in response to a terminal's adaptation request in an ABS initiated adaptation according to a second embodiment of the present disclosure; and

FIG. 6 is an internal block diagram illustrating a terminal according to an embodiment of the present disclosure.

### MODE FOR THE INVENTION

Hereinafter, embodiments according to the present disclosure will be described in detail with reference to the accompanying drawings. In the following description, it should be noted that only a portion required to understand the operation according to the present disclosure will be described, and the description of the remaining portion will be omitted not to obscure the gist of the present disclosure.

In the following embodiments, the constituent elements and features of the present disclosure are combined with one another in a predetermined form. Each constituent element or feature thereof should be considered to be selective as unless otherwise particularly specified. Each constituent element or feature thereof may be implemented in the form of not being combined with any other constituent elements or features. Furthermore, an embodiment of the present disclosure may be also configured by combining some of the constituent elements and/or features. The sequence of the operations described in the embodiments of the present disclosure may be changed. Some of the configurations or features of any embodiment may be included in any other embodiments, or may be replaced with the configurations and features corresponding to the any other embodiments.

Embodiments of the present disclosure are described mainly in relation to the transmission and reception of data between a base station and a terminal. Here, the base station has also the meaning of a terminal node of a network, which directly performs communication with the terminal. In this disclosure, a specific operation described to be performed by a base station may be carried out by an upper node of the base station if necessary.

In other words, it should be understood that various operations carried out for communication with a terminal in a network comprised of a plurality of network nodes including a base station can be carried out by the base station or other network nodes except the base station. The term “base station” may be replaced by a term such as fixed station, Node B, eNode B (eNB), access point, or the like. Furthermore, the term “terminal” may be replaced by a term such as UE (user equipment), MS (mobile station), MSS (mobile subscriber station), or the like.

Embodiments of the present disclosure may be implemented through various means. For example, embodiments of the present disclosure may be implemented by hardware, firmware, software, or any combination thereof.

In case of a hardware implementation, a method according to the embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In case of a firmware or software implementation, a method according to the embodiments of the present disclosure may be implemented in the form of a module, procedure, function, or the like, which performs the functions or operations as described above. The software codes may be stored in a memory unit to be driven by a processor. The memory unit may be located at an inner or outer portion of the processor to send and/or receive data to and/or from the processor by various publicly-known means.

Specific terms used herein are provided to help understanding of the present disclosure, and the use of those specific terms may be replaced with other terms without departing from the technical spirit of the present disclosure.

According to the present disclosure, there is provided a method in which a new QoS parameter is adapted by using an adaptation start time and a method in which a terminal or base station permits (accepts) or rejects a request for adapting a new QoS parameter.

### First Embodiment

### AMS-Initiated Adaptation

According to a first embodiment of the present disclosure, there is provided a case where a new QoS parameter is adapted by a terminal's request for switching or changing a QoS parameter set and a method of allowing the base station to accept (permit) or reject the request.

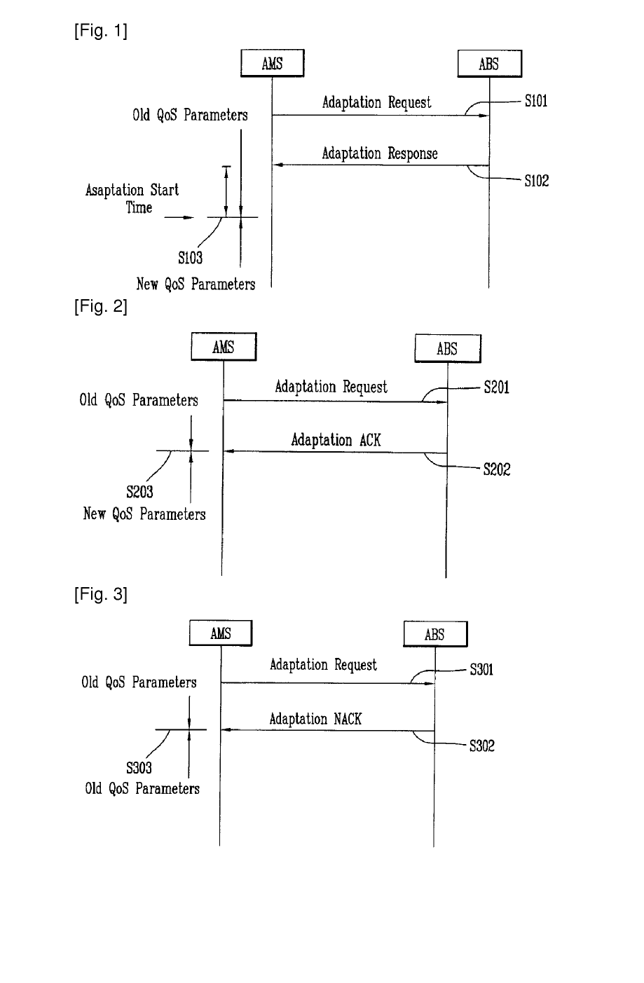

FIG. 1 is a view illustrating a method of allowing a base station to transmit SSSCH including adaptation start time information with respect to a terminal's request for switching or changing a QoS parameter set according to a first embodiment of the present disclosure.

The terminal transmits a first message for requesting the switching or changing of the existing QoS parameter set to the base station (S101). In other words, the terminal may be able to start to change a grant polling interval and a grant size by transmitting the first message.

Here, the first message is any one of a service specific scheduling control header (SSSCH), a quick access message, and a bandwidth request indicator of a feedback channel.

The base station responds to the first message by sending SSSCH to the terminal to permit the adaptation of a QoS parameter set requested by the terminal or allocate other QoS parameters (S102).

Here, the service specific scheduling control header (SSSCH) transmitted by the base station, in other words, the SSSCH received by the terminal from the base station, includes adaptation timing information of the switched or changed QoS parameter set and an indicator indicating whether the adaptation timing information is included in the SSSCH.

The adaptation timing information indicates adaptation start time information for switching or changing to a new QoS parameter set.

Here, the adaptation start time information may be represented as a frame offset form, and in this case, the adaptation start time information indicates to which number of frame the switched or changed QoS parameter set will be adapted after receiving the SSSCH from the base station. In case where the adaptation start time information has a frame form, the adaptation start time information may be represented as from its first frame to eighth frame.

Furthermore, the adaptation start time information may be represented as a frame number to which the switched or changed QoS parameter set is adapted. In this case, the frame number may be represented as the least significant 4 bits.

Furthermore, the SSSCH may further include SSSCH type information for discriminating whether it is a request for switching or changing a QoS parameter set or a response with respect to the request.

The terminal checks the adaptation timing information through a response message, namely, SSSCH, received from the base station, and switches or changes to adapt a new QoS parameter set thereto at the adaptation start time (S103).

Accordingly, the terminal performs an aGP service by adapting a new QoS parameter subsequent to the adaptation start time. Furthermore, the new QoS parameter is maintained until requesting the next switching or changing from the terminal.

In addition, in case of being unable to receive a grant size or grant polling interval (GPI) requested from the base station, the terminal performs an adaptation request again to the base station until receiving the requested grant size or GPI.

An example of a SSSCH format including a QoS parameter adaptation time indicator and adaptation start time information when the base station receives SSSCH from the terminal and transmits SSSCH in response to this is illustrated in the following Table 2.

TABLE 2

| | Size | |
|---|---|---|
| Syntax | (bit) | Notes |
| Service Specific | | |
| Scheduling Control | | |
| Header( ) { | | |
| . . . | | |
| if (scheduling type | | |
| == aGP Service) { | | |
| QoS parameter change | 1 | QoS parameter change indicator |
| indicator | | 0: no change in QoS parameter |
| | | 1: having changes in QoS parameter |
| SCID change indicator | 1 | |
| if (QoS parameter | | |
| change indicator = | | |
| 1){ | | |
| Running Grant Polling | 6 | Indicating new GPI (frames) to use |
| Interval (GPI) | | for future allocation. |
| Reserved | 9 | |
| }else{ | | |
| QoS parameter set | 1 | 0: primary QoS parameter set. |
| switch | | 1: secondary QoS parameter set |
| } | | |
| Adaptation start time | 1 | Indicate whether adaptation start time is |
| indicator | | included in this header |
| | | 0: No Adaptation start time. |
| | | 1: Adaptation start time is included in this |
| | | leader |
| If (Adaptation start | | |
| time indicator == 1) | | |
| { | | |
| Adaptation start time | TBD | Indicates when the changed/switched new |
| | | QoS parameter set is adopted. |

}

| | | |
|---|---|---|
| . . . | . . . | . . . |
| } | | |

Referring to Table 2, SSSCH may include an adaptation start time indicator indicating whether a new QoS parameter set adaptation start time information is included in the SSSCH. For example, when the adaptation start time indicator is set to “1”, it indicates that the adaptation start time information is included in the SSSCH. In this case, the SSSCH may further include adaptation start time information indicating when the new QoS parameter set will be switched or changed.

An example of a SSSCH format showing that the adaptation start time information to which a new QoS parameter set is adapted is expressed as a frame offset format is illustrated in the following Table 3.

TABLE 3

| | Size | |
|---|---|---|
| Syntax | (bit) | Notes |
| Service Specific | | |
| Scheduling Control | | |
| Header( ) { | | |
| . . . | | |
| if (scheduling type == | | |
| aGP Service) { | | |
| QoS parameter change | 1 | QoS parameter change indicator |
| indicator | | 0: no change in QoS parameter |
| | | 1: having changes in QoS parameter |
| SCID change indicator | 1 | |
| if (QoS parameter | | |
| change indicator = 1){ | | |
| Running Grant Polling | 6 | Indicating new GPI (frames) to use |
| Interval (GPI) | | for future allocation. |
| Reserved | 9 | |
| }else{ | | |
| QoS parameter set | 1 | 0: primary QoS parameter set. |
| switch | | 1: secondary QoS parameter set |
| } | | |
| Adaptation start time | 1 | Indicate whether adaptation start time is |
| indicator | | included in this header |
| | | 0: No Adaptation start time. |
| | | 1: Adaptation start time is included in |
| | | this header |
| If (Adaptation start | | |
| time indicator == 1) { | | |
| Adaptation start time | 3 | Indicates when the changed/switched |
| | | new QoS parameter set is adopted. |
| | | 0b000: Current frame |
| | | 0b001: After 1 frame |
| | | 0b010: After 2 frame |
| | | 0b011: After 3 frame |
| | | 0b100: After 4 frame |
| | | 0b101: After 5 frame |
| | | 0b110: After 6 frame |
| | | 0b111: After 7 frame |

}

| | | |
|---|---|---|
| . . . | . . . | . . . |
| } | | |

Referring to Table 3, the adaptation start time of a new QoS parameter set within the SSSCH is represented as a frame offset format, and it indicates to which number of frame (1-8 frame) after receiving a response message with respect to a request for switching or changing the QoS parameter set. For example, when the adaptation start time field is “0b011”, it will be switched or changed to adapt a new QoS parameter set in a third frame or later subsequent to the frame that has received the response message.

An example of a SSSCH format showing that the adaptation start time information to which a new QoS parameter set is adapted is notified through the LSB of a frame number is illustrated in the following Table 4.

TABLE 4

| | Size | |
|---|---|---|
| Syntax | (bit) | Notes |
| Service Specific | | |
| Scheduling Control | | |
| Header( ) { | | |
| . . . | | |
| if (scheduling type == | | |
| aGP Service) { | | |
| QoS parameter change | 1 | QoS parameter change indicator |
| indicator | | 0: no change in QoS parameter |
| | | 1: having changes in QoS parameter |
| SCID change indicator | 1 | |
| if (QoS parameter | | |
| change indicator = 1) { | | |
| Running GrantPolling | 6 | Indicating new GPI (frames) to use |
| Interval (GPI) | | for future allocation. |
| Reserved | 9 | |
| }else{ | | |
| QoS parameter set | 1 | 0: primary QoS parameter set. |
| switch | | 1: secondary QoS parameter set |
| } | | |
| Adaptation start time | 1 | Indicate whether adaptation start time |
| indicator | | is included in this header |
| | | 0: No Adaptation start time. |
| | | 1: Adaptation start time is included in |
| | | this header |
| If (Adaptation start | | |
| time indicator = 1) { | | |
| Adaptation start time | 4 | Indicates when the changed/switched |
| | | new QoS parameter set is adopted. |
| | | Least Significant 4 bits of the |
| | | frame number in which the changed |
| | | QoS parameters or the switched QoS |
| | | parameter set are to be applied. |

}

| | | |
|---|---|---|
| . . . | . . . | . . . |
| } | | |

Referring to Table 4, the adaptation time of a new QoS parameter set is notified by the base station as the LSB of the frame number, and it is switched or changed to adapt new QoS parameters in the frame number. In other words, the base station notifies an adaptation start time to the terminal through the least significant 4 bits of the frame number as illustrated in Table 4.

An example of a SSSCH format including a SSSCH type field is illustrated in the following Table 5.

TABLE 5

| | Size | |
|---|---|---|
| Syntax | (bit) | Notes |
| Service Specific | | |
| Scheduling Control | | |
| Header( ) { | | |
| . . . | | |
| if (scheduling type | | |
| == aGP Service) { | | |
| SSSCH type | 2 | Indicates the SSSCH types |
| | | 0b00: Adaptation Request |
| | | 0b01: Adaptation Response I (Adaptation to |
| | | Adaptation Request with parameter change) |
| | | 0b10: Adaptation ACK (Adaptation response |
| | | to adaptation request without parameter |
| | | change/switch) |
| | | 0b11: Adaptation NACK (Reject to request) |
| If (SSSCH type == | | |
| 0b00 \|\| SSSCH type | | |
| == 0b01) { | | |
| QoS parameter | 1 | QoS parameter change indicator |
| change indicator | | 0: QoS parameter set switching |
| | | 1: QoS parameter change |
| SCID change | 1 | |
| indicator | | |
| if (QoS parameter | | |
| change indicator = | | |
| 1){ | | |
| Running grant size | 14 | Indicating new grant size (bytes) to use |
| | | for future allocation |
| Running Grant | 6 | Indicating new GPI (frames) to use for |
| Polling Interval | | future allocation. |
| (GPI) | | |
| }else{ | | |
| QoS parameter set | 1 | 0: primary QoS parameter set. |
| switch | | 1: secondary QoS parameter set |
| } | | |
| } | | |
| . . . | . . . | . . . |
| } | | |

Referring to Table 5, the SSSCH may include a SSSCH type field indicating whether the SSSCH is a request for switching or changing a QoS parameter set or a response with respect to the request.

For example, when the SSSCH type is “0b00”, the SSSCH indicates a request for switching or changing a QoS parameter set. When the SSSCH type is “0b01”, the SSSCH indicates a response with respect to the request for switching or changing a QoS parameter set.

Furthermore, when the SSSCH type is “0b10”, the SSSCH indicates a permission with respect to the request for switching or changing a QoS parameter set. When the SSSCH type is “0b11”, the SSSCH indicates a rejection with respect to the request for switching or changing a QoS parameter set.

FIG. 2 is a view illustrating a method of allowing the base station to transmit adaptation ACK in response to a terminal's adaptation request in an AMS initiated adaptation according to a first embodiment of the present disclosure.

Referring to FIG. 2, the terminal requests the switching or changing of a quality of service (QoS) parameter set that has been previously used to the base station (S201). In other words, the terminal transmits an adaptation request to the base station. Here, the adaptation request may be requested through any one of a service specific scheduling control header (SSSCH), a quick access message, and a bandwidth request indicator of a feedback channel.

The base station transmits adaptation ACK that has been performed by the SSSCH to the terminal in order to adapt or permit the QoS parameter set requested by the terminal (S202).

Here, the terminal switches or changes to an new QoS parameter set that has requested to the base station at a timing of receiving (subsequent to receiving) the adaptation ACK from the base station (S203).

FIG. 3 is a view illustrating a method of allowing the base station to transmit adaptation NACK in response to a terminal's adaptation request in an AMS initiated adaptation according to a first embodiment of the present disclosure.

Referring to FIG. 3, the terminal requests the switching and changing of a QoS parameter set that has been previously used to the base station (S301). In other words, the terminal transmits an adaptation request to the base station. Here, the adaptation request may be transmitted through any one of a service specific scheduling control header (SSSCH), a quick access message, and a bandwidth request indicator of a feedback channel.

The base station transmits adaptation NACK carried out by SSSCH in order not to adapt the QoS parameter set requested from the terminal, namely, to reject the request (S302).

Here, when the terminal receives adaptation NACK from the base station, the terminal uses the existing QoS parameter set as it is without switching or changing to a new QoS parameter set requested to the base station (S303).

### Second Embodiment

### ABS-Initiated Adaptation

According to a second embodiment of the present disclosure, there is provided a method of adapting a new QoS parameter or maintaining the existing QoS parameter through a terminal's response (permission or rejection) with respect to a base station's request for switching or changing a QoS parameter set.

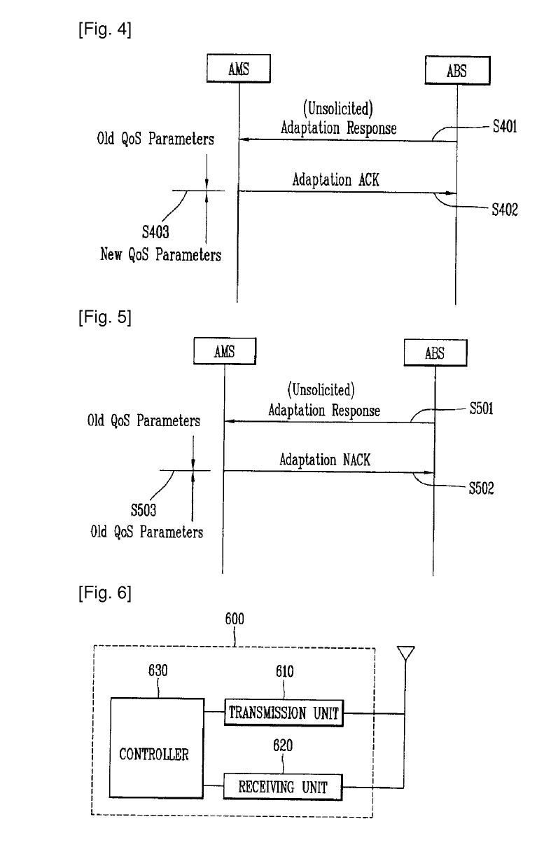

FIG. 4 is a view illustrating a method of allowing the terminal to transmit adaptation ACK in response to a terminal's adaptation request in an ABS initiated adaptation according to a second embodiment of the present disclosure.

Referring to FIG. 4, the base station requests the switching or changing of a QoS parameter set to the terminal (S401). In this case, the base station may request the switching or changing of a QoS parameter set by transmitting an unsolicited adaptation response carried out by SSSCH. Here, the adaptation transmitted by the base station may be changing of a GPI or grant size or switching from a primary QoS parameter set to a secondary QoS parameter set.

The terminal transmits adaptation ACK carried out by SSSCH to the base station to adapt a new QoS parameter set requested from the base station (S402). In other words, when transmitting adaptation ACK to the base station, the terminal adapt a new QoS parameter set requested by the base station.

At this time, the switching or changing to a new QoS parameter set requested by the base station may be adapted subsequent to receiving the adaptation ACK (S403).

FIG. 5 is a view illustrating a method of allowing the terminal to transmit adaptation NACK in response to a terminal's adaptation request in an ABMS initiated adaptation according to a second embodiment of the present disclosure.

Referring to FIG. 5, the base station requests the switching or changing of a QoS parameter set to the terminal (S501). In this case, the base station may request the switching or changing of a QoS parameter set by transmitting an unsolicited adaptation response carried out by SSSCH.

The terminal transmits adaptation NACK carried out by SSSCH to the base station in order not to adapt a new QoS parameter set requested from the base station (S502). In other words, when transmitting adaptation NACK to the base station, the terminal rejects the switching or changing to a new QoS parameter set requested by the base station.

In this case, the terminal uses the existing QoS parameter set as it is (S503).

FIG. 6 is an internal block diagram illustrating a terminal according to an embodiment of the present disclosure.

First, a terminal 600 may include a transmission unit 610, a controller 620, and a receiving unit 630.

In order to provide an aGP (adaptation grant and polling) service in a broadband wireless access system, the base station periodically performs communication with the terminal according to the traffic characteristic and QoS requirement. In this case, the terminal may negotiate with the terminal through only primary SF QoS parameters or negotiate with the terminal using both primary and secondary SF QoS parameters.

The transmission unit 610 transmits a first message for requesting the switching or changing of a QoS parameter set to the base station. In other words, the terminal may start to change a grant polling interval (GPI) or grant size by transmitting the first message to the base station through the transmission unit.

Here, the first message may be any one of a service specific scheduling control header (SSSCH), a quick access message, and a bandwidth request (BR) indicator of a feedback channel.

Furthermore, upon receiving an unsolicited adaptation response from the base station, the transmission unit 610 may transmit a response message with respect to the base station's request. Here, the response message may be adaptation ACK in case of indicating the permission with respect to the base station's request, and adaptation NACK in case of indicating the rejection with respect to the base station's request.

The receiving unit 620 receives a service specific scheduling control header (SSSCH) including adaptation start time information for adapting a new QoS parameter set from the base station.

Here, the service specific scheduling control header (SSSCH) may include at least one of adaptation timing information of the switched or changed QoS parameter set, an indicator indicating whether the adaptation timing information is included in the SSSCH, and SSSCH-type information.

The adaptation timing information may indicate adaptation start time information for switching or changing to a new QoS parameter set.

Here, the adaptation start time information may be represented as a frame offset form, and in this case, the adaptation start time information indicates to which number of frame the switched or changed QoS parameter set will be adapted after receiving the SSSCH from the base station. In case where the adaptation start time information has a frame form, the adaptation start time information may be represented as from its first frame to eighth frame.

Furthermore, the adaptation start time information may be represented as a frame number to which the switched or changed QoS parameter set is adapted. In this case, the frame number may be represented as the least significant 4 bits.

Furthermore, the receiving unit 620 receives an unsolicited adaptation response from the base station, Here, the adaptation indicates to switch or change a QoS parameter set from the base station.

The controller 630 may control to check the adaptation start time information within the SSSCH received from the receiving unit 620 to switch or change to the new QoS parameter set at the checked adaptation start time. The new QoS parameter set may be QoS parameters requested by the terminal or alternative QoS parameters replaced by the base station.

Furthermore, upon receiving SSSCH for requesting the switching or changing of a QoS parameter set from the base station, the controller 630 may control to maintain the existing QoS parameter set or adapt a new QoS parameter set based on a response with respect to the received SSSCH.

1.-16. (canceled)

17. A method for performing uplink scheduling service in a wireless access system, the method comprising:
setting up, by a terminal, a service flow based on a first quality of service (QoS) parameter set;
transmitting, by the terminal, to a base station, an adaptation request message to request a change of the first QoS parameter set;
receiving, by the terminal, from the base station, an adaptation response message as response to the adaptation request message, the adaptation response message including a second QoS parameter set and an adaptation start time, the adaptation start time indicating a start time when the second QoS parameter set is applied; and
adapting, by the terminal, the second QoS parameter set to the service flow at the adaptation start time,
wherein the second QoS parameter set is different from the first QoS parameter set.

18. The method of claim 17, wherein the first and second QoS parameter sets include a grant and polling interval (GPI) and a grant size.

19. The method of claim 17, wherein the adaptation request message is carried by a first service specific scheduling control header (SSSCH).

20. The method of claim 19, wherein the first SSSCH includes the second QoS parameter set.

21. The method of claim 19, wherein the first SSSCH includes a SSSCH type indicator for indicating that the adaptation request message is carried by the first SSSCH.

22. The method of claim 17, wherein the adaptation response message is carried by a second SSSCH.

23. The method of claim 22, wherein the second SSSCH includes a SSSCH type indicator for indicating that the adaptation response message is carried by the second SSSCH.

24. The method of claim 17, wherein the adaptation start time indicates least significant four bits of a frame number in which the second parameter set is applied.

25. A terminal for performing uplink scheduling service in a wireless access system, the terminal comprising:
a controller configured to set up a service flow based on a first quality of service (QoS) parameter set;
a transmission unit configured to transmit, to a base station, an adaptation request message to request a change of the first QoS parameter set; and
a receiving unit configured to receive, from the base station, an adaptation response message as response to the adaptation request message, the adaptation response message including a second QoS parameter set and an adaptation start time, the adaptation start time indicating a start time when the second QoS parameter set is applied,
wherein the controller configured to adapt the second QoS parameter set to the service flow at the adaptation start time and the second QoS parameter set is different from the first QoS parameter set.

26. The terminal of claim 25, wherein the first and second QoS parameter sets include a grant and polling interval (GPI) and a grant size.

27. The terminal of claim 25, wherein the adaptation response message is carried by a service specific scheduling control header (SSSCH).

28. The terminal of claim 25, wherein the adaptation start time indicates least significant four bits of a frame number in which the second parameter set is applied.
